(19) United States
(12) Patent Application Publication
(10) Pub. No.: US 2010/0284738 A1
(43) Pub. Date: Nov. 11, 2010

(54) Connection devices

(75) Inventors: Paul Edward Robinson, Cleveland (GB); Neville Teasdale, Cleveland (GB)

Correspondence Address: LUNDEEN & LUNDEEN, PLLC, 2710 Louisiana, HOUSTON, TX, 77006, US

(73) Assignee: INTERNATIONAL PIPELINE PRODUCTS LIMITED, North Yorkshire (GB)

(21) Appl. No.: 12/435,606

(22) Filed: May 5, 2009

(51) Int. Cl. F16L 17/10; F16L 55/00

(52) U.S. Cl. 403/408.1; 285/93; 403/5; 403/27

(57) ABSTRACT

A connection device, unit incorporating a connection device, method of connecting a unit to a pipe, method of using a connection device and method of passing a device along a pipeline are provided.

In one embodiment, a connection device (5) is disclosed which includes a through aperture extending between a first end of the connection device and a second end of the connection device so as to receive a section of a pipe (1), a support element (7) provided around the through aperture and one or more inflatable elements (23) provided inside the support element and around the through aperture. Each inflatable element has an inlet for the introduction and/or removal of an inflating medium. Inflation of the inflatable elements causes the connection device to firmly grip and so become anchored on the pipe.

### FIELD OF THE INVENTION

The present invention is concerned with connection devices, particularly, but not exclusively, for connecting units to a pipeline using the connection device.

### BACKGROUND OF THE INVENTION

For various reasons, it is necessary to connect units to pipelines. The unit may, for instance, be a receiving and/or launching unit for a pig for use in inspecting pipelines. Such units are frequently employed in the oil industry. Other examples would include a connection of a further pipeline to an existing pipeline.

Whilst it is possible to connect a unit to an existing pipeline using opposing flanges joined by nuts and bolts, such flanges frequently do not exist at the relevant location on the pipeline. Attaching such flanges by welding is often not a viable solution. This can be due to the safety considerations involved in accessing a location with welding equipment and the alterations to the location which need to be made to allow welding. Problems can also arise due to the practical difficulties in physically accessing the location for welding purposes (for instance due to its positioning on the underside of an offshore rig), or due to the practical difficulties in welding to the pipeline due to the material from which the pipeline is made.

### SUMMARY OF THE INVENTION

The present invention provides an alternative connection device for use in connecting a unit to a pipeline, various units incorporating such devices and methods for using such devices.

According to a first aspect of the invention there is provided a connection device, the connection device including:
a through aperture extending between a first end of the connection device and a second end of the connection device;
a support element provided around the through aperture;
one or more inflatable elements provided inside the support element and around the through aperture, each inflatable element having an inlet for the introduction and/or removal of an inflating medium.

The first aspect of the invention may include any of the features, options or possibilities set out elsewhere in this document.

According to a second aspect of the invention there is provided a method of connecting a unit to a pipe, the method using a connection device, the method including:

a) providing a connection device, the connection device including:
a through aperture extending between a first end of the connection device and a second end of the connection device; a support element provided around the through aperture; one or more inflatable elements provided inside the support element and around the through aperture, each inflatable element having an inlet for the introduction and/or removal of an inflating medium;

b) placing a part of the pipe in the through aperture of the connection device;

c) introducing inflating medium to one or more of the one or more inflatable elements to inflated them into contact with the outside of the pipe;

wherein the unit is attached to the connection device.

The second aspect of the invention may include any of the features, options or possibilities set out elsewhere in this document.

According to a third aspect of the invention there is provided a unit incorporating a connection device, the connection device including:
a through aperture extending between a first end of the connection device and a second end of the connection device;
a support element provided around the through aperture;
one or more inflatable elements provided inside the support element and around the through aperture, each inflatable element having an inlet for the introduction and/or removal of an inflating medium.

The third aspect of the invention may include any of the features, options or possibilities set out elsewhere in this document.

According to a fourth aspect of the invention there is provided a method of passing a device along a pipeline, the method including:

a) providing a connection device, the connection device including:
a through aperture extending between a first end of the connection device and a second end of the connection device; a support element provided around the through aperture; one or more inflatable elements provided inside the support element and around the through aperture, each inflatable element having an inlet for the introduction and/or removal of an inflating medium;

b) placing a part of the pipe in the through aperture of the connection device;

c) introducing inflating medium to one or more of the one or more inflatable elements to inflated them into contact with the outside of the pipe;

wherein the unit is attached to the connection device;

d) passing a device along the pipeline to the unit or from the unit.

The fourth aspect of the invention may include any of the features, options or possibilities set out elsewhere in this document.

Any of the aspects of the invention may include features, options or possibilities from amongst the following.

The through aperture is preferably aligned on an axis. The through aperture preferably has a cross-section which is considered perpendicular to the through aperture axis.

The through aperture may be of a constant cross-section between the first end and second end of the connection device. The through aperture may be of a constant cross-section between that part of the support element which is closest to the first end of the connection device and that part of the support element which is closets to the second end of the connection device. Preferably the through aperture is of a constant cross-section between that part of the one or more inflatable elements which is closest to the first end of the connection device and that part of the one or more inflatable elements which is closets to the second end of the connection device.

The through aperture may have a minimum cross-section which is a constant cross-section between the first end and second end of the connection device. The through aperture may have a minimum cross-section which is a constant cross-section between that part of the support element which is closest to the first end of the connection device and that part of the support element which is closets to the second end of the connection device. Preferably the through aperture has a minimum cross-section which is a constant cross-section between that part of the one or more inflatable elements which is closest to the first end of the connection device and that part of the one or more inflatable elements which is closets to the second end of the connection device. The minium cross-section may be that cross-section which exists throughout the distance between the first and second ends of the connection device.

The minimum cross-section may be exceeded at one or more locations between the first and second ends of the connection device. The minimum cross-section may be exceeded between a one inflatable element and another inflatable element. The minimum cross-section may be exceeded at the first end and/or second end of the connection device.

The cross-section of the through aperture may be of a constant cross-section with the one or more inflatable elements deflated and/or inflated and/or particularly when in use. The cross-section of the through aperture may be of a constant cross-section with the one or more inflatable elements in contact with a pipe.

The constant cross-section may be defined by the inflatable elements alone.

The through aperture may have a cross-section, and preferably at least a minimum cross-section, which is circular.

The through aperture may have a diameter greater than 100 mm, preferably greater than 200 mm. Other sizes may be provided to accommodate other pipe sizes.

The through aperture may have a length of greater than 200 mm and preferably greater than 300 mm. Other sizes may be provided to accommodate other pipe sizes.

The length from the edge closest to the first end of the connection device of the inflatable element closest to the first end of the connection device to the edge closest the second end of the connection device of the inflatable element closest to the second end of the connection device may be at least 200 mm and more preferably at least 300 mm. This length may be less than 1000 mm and preferably less than 600 mm.

The support element may be a tube. Preferably the support element has a circular cross-section. Preferably the support element has a constant minimum cross-section and/or maximum cross-section. Preferably the extent of the support element along the axis of the connection device is greater than the maximum extent of the one or more inflatable elements. The support element may be of metal.

A flange may be provided at or towards on or both ends of the support element. The flange(s) may be radially extending. The flange(s) may be provided directly on the support element, particularly by welding. The flange(s) may extend outward from the support element. One or more through apertures may be provided in the flange(s). Preferably the through aperture receives a fixing, such as a bolt. Preferably a plurality of through apertures are provided in the flange(s), ideally evenly spaced around the perimeter thereof. The flange(s) may be of metal.

A flange of the connection device may be used to connect the connection device to a unit. A flange of the connection device may be connected to a further flange.

A further flange, potentially radially extending, may be provided at one or both ends of the connection device. The further flange is preferably aligned with the axis of the through aperture. The further flange may have a circular perimeter. The through aperture in the further flange may have a circular through aperture. The through aperture in the further flange may have a minium cross-section at least equal to, and more preferably greater than, the minimum cross-section of the through aperture. The edge of the through aperture, particularly the outer edge may be chamfered. The further flange may be releasably connected to the support element, preferably through a flange. The further flange(s) may be of metal.

Where the connection device is connected to another unit, for instance by a flange on the connection device, the connection is preferably made to a flange on the another unit. The another unit flange, potentially radially extending, is preferably aligned with the axis of the through aperture. The another unit flange may have a circular perimeter. The through aperture in the another unit flange may have a circular through aperture. The through aperture in the another unit flange may have a minium cross-section at least equal to, and more preferably greater than, the minimum cross-section of the through aperture. The edge of the through aperture, particularly the outer edge may be chamfered. The another unit flange may be releasably connected to the flange of the connection device, for instance using one or more nuts and bolts. The another unit flange may be of metal.

The connection device may be provided with one or more attachment locations. The one or more attachment locations may be used to restrain the connection device and/or prevent extreme movement, such as dropping, of the connection device. One or more attachment locations in the form of a web may be provided. The web may have one or more through apertures, for instance to receive a releasable fastener. One or more restraints may be connect to the connection device and/or may be connected to a part of the superstructure in the area around the connection device. The one or more restraints may resist movement of the connection device away from its position of use. The one or more restraints may resist dropping and/or loss of the connection device. One or more further such attachment locations and/or restraints may be used on a unit attached to the connection device.

Preferably at least two inflatable elements are provided and more preferably at least four. Preferably the supply of inflating medium to at least one of the inflatable elements is separate from the supply to at least one of the other inflatable elements. Where four inflatable elements are provided, preferably two received inflating medium from one supply and the other two receive it from a separate supply. Preferably the two of the inflatable elements in one pair are the two towards one end of the connection device and the other pair are the two towards the other end of the connection device.

An inflatable element may be annular. An inflatable element may have an inner surface which is concentric with its outer surface. The outer surface may contact the support element directly. The inner surface may directly or indirectly contact the outside of the pipe in use. An inflatable element may have a first side surface which is parallel to its second side surface. Preferably the side surfaces extend radially about the through aperture axis. All of the inflatable elements may be so provided.

An inflatable element may be a tyre. An inflatable element may be made of polyurethane. An inflatable element may be inflated by varying the volume of a void within the inflatable element. The void may be annular. All of the inflatable elements may be so provided.

An inflatable element may be provided with a surface material over at least part of its surface opposing the through aperture. The surface material preferably has a coefficient of friction greater than that of the material forming the inflatable element itself. The surface material may be embedded in the material of the inflatable element. The surface material may be provided as a separate component attached to the inflatable element. The surface material may be a grit. One or more of the inflatable elements may be so provided, particularly the inflatable element nearest the first end of the connection device and/or the inflatable element nearest the second end of the connection device.

An inflatable element may be provided with a non-constant surface profile over at least part of its surface opposing the through aperture. The surface profile may be provided by one or more ribs. The ribs may be spaced along the axis of the through aperture. The non-constant surface profile may be provided in the material of the inflatable element. The non-constant surface profile may be provided by a separate component attached to the inflatable element. One or more of the inflatable elements may be so provided, particularly the inflatable element(s) nearest the middle of the connection device and/or inside of the inflatable element nearest the first end of the connection device and/or inside the inflatable element nearest the second end of the connection device.

An inflatable element may contact one or two adjacent inflatable elements, but is preferably spaced from any adjacent inflatable elements. An inflatable element may be spaced from an adjacent inflatable element by a spacer. The spacer may be in the form of a flange. The spacer may be provided on the inside of the support element. The spacer may extend radially inward. The inward extent may be less than the inward extent of the inflatable element, preferably at least when the inflatable element is in an inflated state. The space may have a constant width, considered parallel to the axis of the through aperture, throughout its radial extent. The spacer may be of metal. The inflatable element closest to an end of the connection device may have a element extend radially inward alongside it. The inward extent may be less than the inward extent of the inflatable element, preferably at least when the inflatable element is in an inflated state. The element may be the further flange or the another unit flange.

An inflatable element may have a first inflated state and a second deflated state. The deflated state may be the state assumed when the pressure applied to the inflating medium is atmospheric. The inflated state may be a state assumed when the pressure applied to the inflating medium is above atmospheric. Preferably the inflatable element has a through aperture whose minimum cross-section is less than the maximum cross-section of the pipe or other unit to be sealed, when in the deflated state. Preferably the inflatable element has a through aperture whose minimum cross-section is equal to the maximum cross-section of the pipe or other unit to be sealed, when in the inflated state. Preferably movement of an inflatable element away from the axis of the through aperture is restrained during transition between the inflated and deflated state and/or vice versa and/or whilst in the inflated state. Preferably movement of an inflatable element along the axis of the through aperture is restrained during transition between the inflated and deflated state and/or vice versa and/or whilst in the inflated state.

The inflating medium may be a fluid and as such may be a liquid or gas. The inflating gas may be argon. The inflating fluid is preferably hydraulic fluid. The inflating medium is preferably provided via a feed inlet. The feed inlet is preferably provided through the support element. Preferably a separate feed inlet is provided for each inflatable element. The feed inlet is preferably provided with a connector. The connector is preferably connected, at least in use, to a medium supply line. The medium supply line is preferably connected, at least in use, to a medium supply. The medium supply may be provided under pressure by a pump. Control means, such as a valve, may be provided in relation to each medium supply line and/or each pair of medium supply lines.

A through bore may be provided in the support element. The inside of the through bore preferably connects to the space between the inside of the connection device and the outside of the pipeline. The through bore may be position between two inflatable elements and preferably at the middle of the connection device and/or support element and/or array of inflatable elements. The through bore is preferably connected to a pressure monitor or indicator.

Preferably the connection device is intended for mounting on a pipe, for instance a pipe that is a part of a pipeline. A part of the part is preferably received within the through aperture of the connection device in use.

The connection device may be connected to another unit and/or include another unit to which it is connected. The another unit may be a further connection device. The another unit may be a unit for attachment to the end of a pipe. The another unit may be a unit for introducing a device into a pipeline and/or for receiving a device from a pipeline. The device may be a pig. The another unit may be another pipe. The method of passing the device along a pipeline may include the step of collecting information on the pipeline and/or a step of altering the pipeline, for instance via cleaning or repair.

The another unit may include a first portion which is provided adjacent to the pipe. The first portion may have an external cross-section corresponding to the external cross-section of the pipe. The first portion may have an internal cross-section, particularly when receiving a device from the pipe, which is greater than or equal to the internal cross-section of the pipe. The first portion may have an internal cross-section, particularly when providing a device to the pipe, which is less than or equal to the internal cross-section of the pipe. The another unit may include a further portion whose cross-section increases away from end of the pipe and/or away from the connection device. The another unit may include another portion which has a minium cross-section which is greater than the minimum cross-section of the connection device and/or another unit first portion and/or another unit further portion and/or the maximum cross-section of the device, such as a pig. The another unit may be provided with a sealable aperture for removing medium from the inside of the another unit. The another unit may be provided with a releasable end plate. The another unit may be provided with a device or pig passage indicator.

Where the another unit is another pipe, the another pipe may be connected to the pipe using the one connection device with a part of the another pipe received therein, but is more preferably connected using another connection device as well.

Another connection device may be attached to the connection device. The another connection device may have a structure according to any of the features options or possibilities of the present invention. The another connection device may be provided with an equivalent or different structure to the connection device. The another connection device may be attached to the connection device using one or more releasable fastenings, such as nuts and bolts. The attachment may be between a flange of the connection device and a flange, preferably the equivalent flange, of the another connection device.

Where the another connection device and connection device are used to join another pipe to a pipe, preferably a part of the pipe is received within the connection device and a part of the another device is received within the another connection device. Preferably no part of the another pipe is within the connection device and/or no part of the pipe is within the another connection device.

### BRIEF DESCRIPTION OF THE DRAWINGS

Various embodiments of the invention will now be described, by way of example only, and with reference to the drawings in which:

FIG. 1 is a cross-sectional view through a connection device according to one embodiment of the invention;

FIG. 2 is a cross-sectional illustration of the connection device of FIG. 1 in use to connect a pig receiver to a pipeline; and

FIG. 3 shows a second embodiment of the invention featuring two connection devices coupled together and used to join two sections of pipeline together.

### DETAILED DESCRIPTION OF THE DRAWINGS

A variety of tasks call for the connection of a unit temporarily to a pipeline. Such situations include where a normally stopped end of the pipeline is opened to allow access to the pipeline. After use, the stopper is returned to seal the pipeline. In an another situation, a break is made in the pipeline, with a section being removed to allow access into it. Again the removed section of pipeline is returned and reconnected once the task had been completed.

An example of such a task is the inspection of the internals of a pipeline using an inspection unit, commonly referred to as a pig. The inspection may consider the length of pipeline stretching between one oil rig and another, with only that part of the pipeline at each of the rigs being physically accessible. The intervening section may be underground and/or underwater. To perform the task, a break is made in the existing pipeline by disconnecting and removing a section of the pipeline. This results in an open end to the pipeline. An open end to the pipeline can also exist where a spur to the pipeline is provided and the stopper normally present is removed.

Having provided the open end, a pig launching and/or receiving unit is connected to the end of the pipeline. Because the pig launch and reception is conducted under pressurised conditions a connection between the unit and the pipeline which can withstand the relevant pressures is necessary. A reliable and strong fixing of the unit in position is thus necessary.

The addition of fixing locations to the pipeline is a possibility, with the unit being mounted using those fixing locations. However, their addition is often not practical due to difficulties with the accessing of the location and/or safety issues with the location not allow welding of fixing locations on to the pipeline.

The invention provides an alternative device for securing a unit to a pipeline which avoids the need for welding or other techniques requiring the addition of fixing locations onto the pipeline.

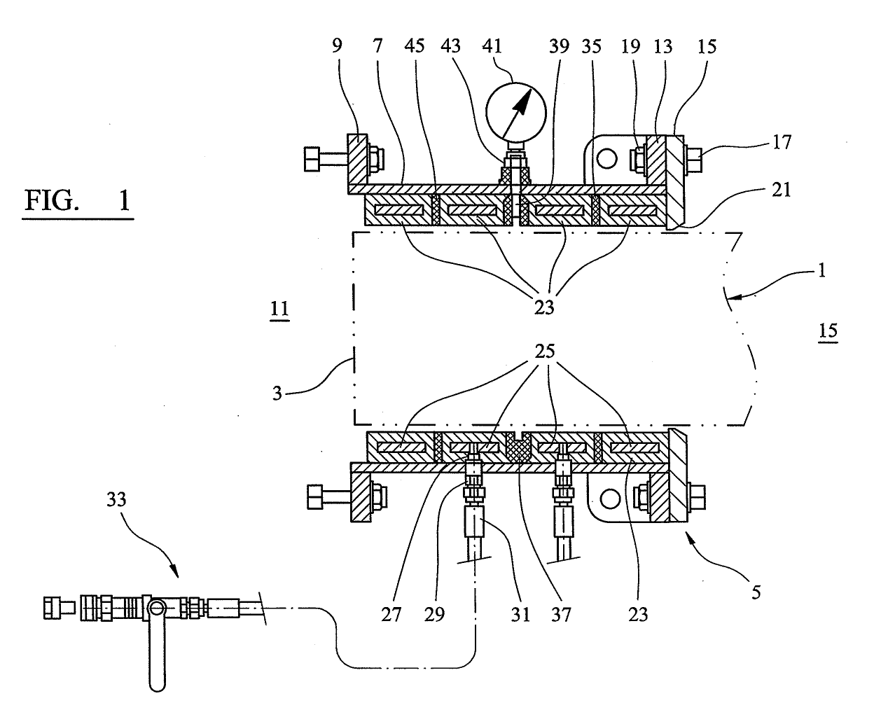

Referring to FIG. 1, a section of pipeline 1 is shown with an end face 3. The connection device 5 has an annular through opening which is configured to be greater than the outside diameter of the pipeline 1 on which it is to be used by a tolerance. The outside diameter of pipelines 1 is known and is constant, whereas the internal diameter varies according to the wall thickness of the pipeline. Thus by providing an externally mounted connection device 5, the connection device 5 is more versatile than if it uses part of the internal surface.

The connection device 5 includes an elongate annular element 7 which has an annular flange 9 welded to it at one end, the outer end 11 of the connection device 5. A separate annular flange 13 is welded to the elongate annular element 7 at the inner end 15 of the connection unit 5. This annular flange 13 is fastened to a further flange 16 by means of nuts 17 and bolts 19. The further flange 16 has an internal aperture generally corresponding to the external diameter of the pipeline 1 plus a tolerance. A chamfer 21 assists in directing the positioning the connecting device 5 over the end of the pipeline 1.

Inside the annular element 7 four annular inflatable elements 23 are provided. Each of the annular inflatable elements 23 has an annular void 25 within it and these annular voids 25 are connected to hydraulic feed 27 which in turn has a releasable connection 29 to a hydraulic pipeline 31. The hydraulic pipeline 31 is connected to a remote hydraulic fluid supply and a control unit 33 therefore. The circuit for the right-hand two annular inflatable elements 23 is separate from the circuit for the left-hand two. For the sake of simplicity, only two hydraulic fluid connectors are shown in FIG. 1.

The introduction of hydraulic fluid through the control unit 33, hydraulic pipeline 31, connector 29 and feed 27 leads to the hydraulic fluid entering the annular void 25. This process occurs separately in respect of each of the four annular voids 25. The hydraulic fluid pressure within the annular void 25 causes that annular void 25 to expand and hence causes expansion of the annular inflatable element 23 which surrounds it.

The inflation of the annular inflatable element 23 is constrained in the following manner. Outside of the annular inflatable element 23 is the elongate annular element 7 and this provides a rigid base to support the inward expansion. With respect to the inflatable element 23 closest to the inner end 15 of the connection device 5, the inflation is also constrained by the further flange 16 and a spacer flange 35 provided between that annular inflatable element 23 and the next one to it. The next annular inflatable element 23 inward from the inner end 15 is constrained by the annular elongate element 7, the spacer flange 35 and a spacer element 37. The next, third, annular inflatable element 23 is constrained by the spacer element 37 and a spacer flange 45. The spacer flange 45 also serves to constrain the final annular inflatable element 23 closest to the outer end 11 of the connection device 5. In use, this annular inflatable element 23 is also constrained by a part of the unit to which connection is made to support and constrain its outside wall. Alternatively, a flange element (not shown) of similar configuration to the element 15 could be provided to assist in constraining this annular inflation element 23.

The spacer element 37 has within it a bore 39 which provides access to a pressure monitor 41 through a connection 43. The pressure monitor 41 allows for the fluid pressure between the inside of the connection device 5 of the outside of the pipeline 1 to be monitored so as to detect potential leaks along this flow path.

The various flanges 9, 13, 16, annular element 7 and spacers 35, 37, 45 are of metal, for instance stainless steel. The annular inflatable elements 3 are of polyethylene.

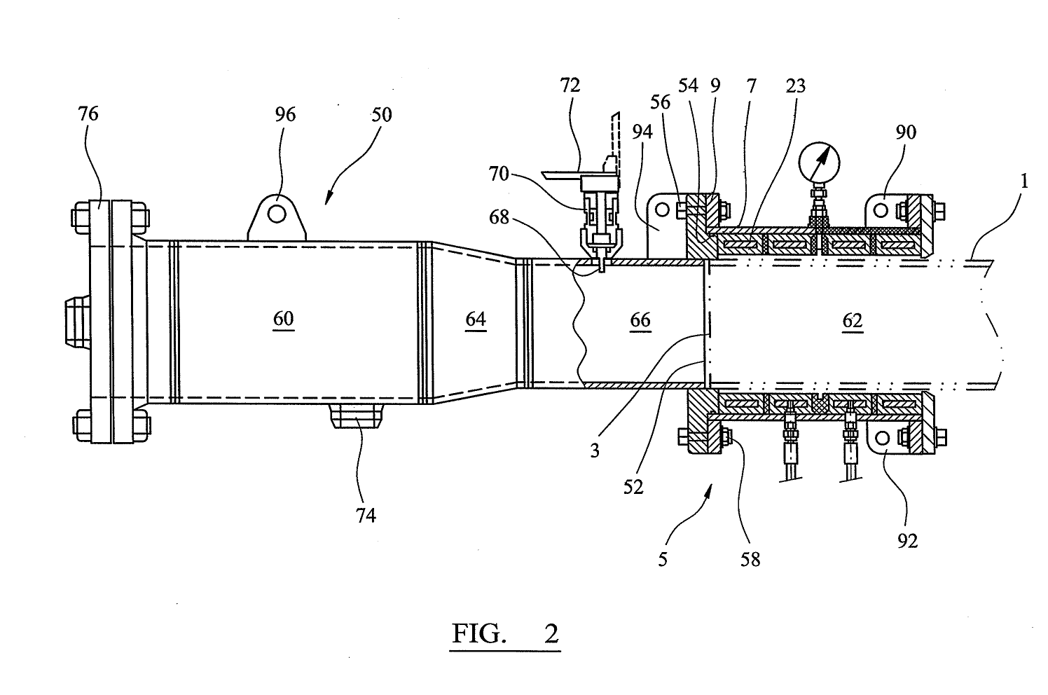

One manner of use for the connection device 5 is shown in FIG. 2. In this case, the connection device 5 has been placed on the end of a pipeline 1 in a similar manner to that described in FIG. 1. To secure the connection device 5 firmly to the outside of the pipeline 1, hydraulic fluid is fed to the inflatable annular elements 23 and pressure is maintained so as to maintain those elements 23 in their expanded state. As a consequence, the inside surface of each of the annular inflatable elements 23 is pushed against the outside of the pipeline 1.

The annular inflatable elements 23 provided at each end 11, 15 of the connection device 5 are provided with a gritted surface which contacts the pipeline in use. This gritted surface increases the grip between element 23 and the surface of the pipeline 1 in use. The two inner inflatable annular elements 23 are provided with a series of ridges which improve the sealing effect on the external surface of the pipeline 1.

The connection device 5 can be introduced and secured int this way to the pipeline 1 before the unit to be connected is then connected to the connection device 5. However, in many cases it will be more convenient to attach the connection device 5 to a unit, such as a pig receiver 50, before attaching the connection device 5 to the pipeline 1.

A pig receiving unit 50 mounted on a connection device 5 is shown in FIG. 2. The configuration is such that the end face 52 of the pig receiving unit 50 is in proximity with the end face 3 of the pipeline 1. Pre-welded to the end portion of the pig receiving unit 50 is a flange 54. In the assembled position shown, this abuts the flange 9 on the connection device 5 and the end face of the annular elongate element 7. The flange 54 also serves to constrain the end of the annular inflatable element 23.

The pig receiving unit 50 is connected to the connection device via nuts 56 and bolts 58 which engage flange 54 of the pig receiving unit 50 and flange 9 of the connection device 5. This provides a secure mounting for the pig receiving unit 50 on the connection device 5.

In this configuration, the inside of the pipeline 1 is in communication with the end portion void 66 of the pig receiving unit 5 and hence, via the reducer void 64, with the internal void 60 of the pig receiving unit 5. When used as a pig receiving unit 5, therefore, the pig can be introduced at a location remote, pass down the pipeline 1 and reach the internal void 60. During the pig's passage through end portion 66 it impacts upon the pin 68 protruding from the bottom of pig passage indicator 70. As a result of the passage of the pig, the indicator flag 72 passes from the pre-triggered position shown, to the triggered position shown in FIG. 2 in dotted outline.

After depressurisation of the pipeline 1 and hence inside of the pig receiving unit 50, the gas or liquid used to propel the pig can be removed through bleed outlet 74. The nuts and bolts which attach the end plate 76 to the end of the pig receiving unit 50 can then be undone and the end plate 76 removed so as to allow access for removal of the pig.

Tests have shown that even with an internal pressure of over 29 bar that only two of the annular inflatable elements 23 must be in their inflated state for the system to function successfully. Thus the redundancy in the hydraulic circuits and annular inflatable elements 23 provides an additional safeguard.

In the particular form shown in FIGS. 1 and 2, the connection device 5 is provided with a series of webs 90 pre-welded to the connection device 5, and having through apertures 92. These allow for cables to be releasably secured to the connection device 5 and also be secured to anchor locations on the surrounding superstructure. Significantly, such a mounting provides additional restraint for the connection device 5 on the pipeline 1. It also provides a safeguard against the connection device 5 being dropped before or after use and hence falling. If used on the underside of an oil rig, this could lead to loss of the connection device 5 into the ocean.

Further attachment locations 94 and 96 can be provided on the pig receiving unit 50 and used in the equivalent manner.

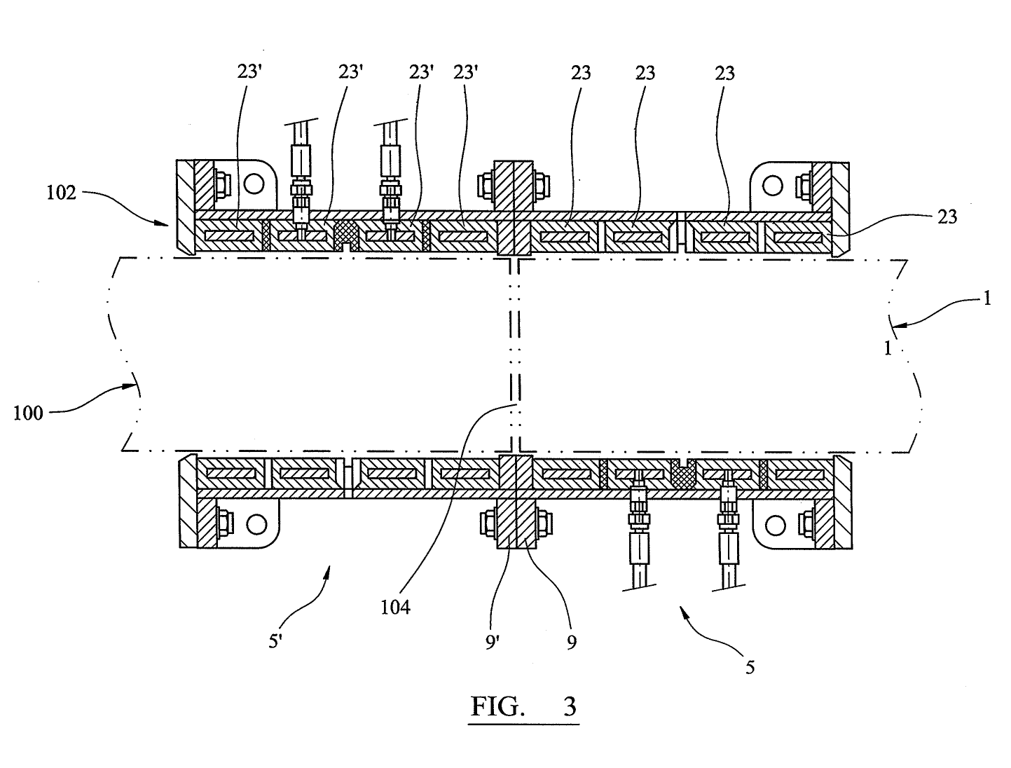

As well as being useful in the context of connecting a pig receiving and/or launching unit 50 to a pipeline 1, the present invention is useful in a variety of situations requiring connection of a unit to a pipeline. Another example of such a use is shown in FIG. 3 where a second pipeline 100 is to be connected to the first pipeline 1. For this purpose two connection devices 5 and 5′ are used.

The two connection devices 5 and 5′ are joined together by a series of nuts and bolts which pass through opposing flanges 9 and 9′ on the two connection device 5 and 5′. Secure fastening of the two connection devices 5 and 5′ together is thus provided. The combined connection devices 5, 5′ can then be slid over the end of one of the pipelines, say pipeline 1. If necessary the combined connection devices 5, 5′ can be slid down pipeline 1 until the end face 3 of the pipeline reaches or protrudes from the end 102 of the connection device 5′. This provides plenty of room in which to introduce the second pipeline 100. With the second pipeline 100 in position, the combined connection device 5, 5′ can be slid back and over the end of the second pipeline 100. The combined connection device 5, 5′ is positioned such that the joint 104 between the first pipeline 1 and second pipeline 100 is aligned with the junction between the connection device 5 and connection device 5′.

Once aligned, the hydraulic fluid can be introduced to the various annular inflatable elements 23, 23′ so as to firmly anchor the connection devices 5, 5′ on the pipelines 1 and 100. As a consequence firm connection of the pipeline 1 and 100 together is provided.

We claim:

1. A connection device, the connection device including:
a through aperture extending between a first end of the connection device and a second end of the connection device;
a support element provided around the through aperture;
one or more inflatable elements provided inside the support element and around the through aperture, each inflatable element having an inlet for the introduction and/or removal of an inflating medium.

2. A connection device according to claim 1 in which at least two inflatable elements are provided.

3. A connection device according to claim 2 in which the supply of inflating medium to at least one of the inflatable elements is separate from the supply to at least one of the other inflatable elements.

4. A connection device according to claim 1 in which an inflatable element is annular.

5. A connection device according to claim 1 in which an inflatable element has an outer surface which contacts a support element directly and/or an inflatable element has an inner surface which contacts the outside of the pipe, in use, directly or indirectly.

6. A connection device according to claim 1 in which an inflatable element is inflated by varying the volume of a void within the inflatable element.

7. A connection device according to claim 1 in which an inflatable element is provided with a surface material over at least part of its surface opposing the through aperture and the surface material has a coefficient of friction greater than that of the material forming the inflatable element itself.

8. A connection device according to claim 7 in which the surface material is embedded in the material of the inflatable element or is provided as a separate component attached to the inflatable element.

9. A connection device according to claim 1 in which an inflatable element is provided with a non-constant surface profile over at least part of its surface opposing the through aperture.

10. A connection device according to claim 9 in which the non-constant surface profile is provided by one or more ribs.

11. A connection device according to claim 1 in which an inflatable element is spaced from an adjacent inflatable element by a spacer.

12. A connection device according to claim 1 in which a spacer is provided on the inside of a support element, the spacer extends radially inward and the inward extent is less than the inward extent of the inflatable element, at least when the inflatable element is in an inflated state.

13. A connection device according to claim 1 in which an inflatable element has a first inflated state and a second deflated state, an inflatable element having a through aperture whose minimum cross-section is less than the maximum cross-section of the pipe or other unit to be sealed, when in the deflated state.

14. A connection device according to claim 1 in which a support element is provided for an inflatable element and the support element has a circular cross-section.

15. A connection device according to claim 14 in which a flange is provided at or towards one or both ends of the support element.

16. A connection device according to claim 15 in which the flange(s) are radially extending and the flange(s) extend outward from the support element and one or more through apertures are provided in the flange(s).

17. A connection device according to claim 15 in which a further flange is provided at one or both ends of the connection device, the further flange(s) having a circular through aperture.

18. A connection device according to claim 1 in which the connection device is provided with one or more attachment locations.

19. A connection device according to claim 1 in which a through bore is provided in the support element, the inside of the through bore connects to the space between the inside of the connection device and the outside of the pipeline.

20. A connection device according to claim 19 in which the through bore is positioned between two inflatable elements.

21. A connection device according to claim 19 in which the through bore is connected to a pressure monitor or indicator.

22. A unit incorporating a connection device, the connection device including:
a through aperture extending between a first end of the connection device and a second end of the connection device;
a support element provided around the through aperture;
one or more inflatable elements provided inside the support element and around the through aperture, each inflatable element having an inlet for the introduction and/or removal of an inflating medium.

23. A unit according to claim 22 in which the connection device is connected to a further connection device or is connected to another unit for attachment to the end of a pipe.

24. A unit according to claim 23 in which the another unit for attachment to the end of a pipe is a unit for introducing a device into a pipeline and/or for receiving a device from a pipeline.

25. A unit according to claim 23 in which the another unit is another pipe.

26. A unit according to claim 22 in which a flange is provided at or towards one or both ends of a support element, the flange(s) are radially extending and the flange(s) extend outward from the support element and one or more through apertures are provided in the flange(s) and the flange(s) are used to connect the connection device to a unit.

27. A method of connecting a unit to a pipe, the method using a connection device, the method including:
a) providing a connection device, the connection device including:
a through aperture extending between a first end of the connection device and a second end of the connection device; a support element provided around the through aperture; one or more inflatable elements provided inside the support element and around the through aperture, each inflatable element having an inlet for the introduction and/or removal of an inflating medium;
b) placing a part of the pipe in the through aperture of the connection device;
c) introducing inflating medium to one or more of the one or more inflatable elements to inflate them into contact with the outside of the pipe;
wherein the unit is attached to the connection device.

28. A method according to claim 27 in which an inflatable element has a first inflated state and a second deflated state, and in which movement of an inflatable element away from the axis of the through aperture is restrained during transition between the inflated and deflated state and/or vice versa and/or whilst in the inflated state.

29. A method according to claim 28 in which an inflatable element has a first inflated state and a second deflated state, and in which movement of an inflatable element along the axis of the through aperture is restrained during transition between the inflated and deflated state and/or vice versa and/or whilst in the inflated state.

30. A method according to claim 27 in which the connection device is provided with one or more attachment locations and the one or more attachment locations are used to restrain the connection device and/or prevent extreme movement, such as dropping, of the connection device.

31. A method according to claim 27 in which one or more restraints are connected to the connection device and/or connected to a part of the superstructure in the area around the connection device.

32. A method of passing a device along a pipeline, the method including:
a) providing a connection device, the connection device including:
a through aperture extending between a first end of the connection device and a second end of the connection device; a support element provided around the through aperture; one or more inflatable elements provided inside the support element and around the through aperture, each inflatable element having an inlet for the introduction and/or removal of an inflating medium;
b) placing a part of the pipe in the through aperture of the connection device;
c) introducing inflating medium to one or more of the one or more inflatable elements to inflate them into contact with the outside of the pipe;
wherein the unit is attached to the connection device;
d) passing a device along the pipeline to the unit or from the unit.

33. A method according to claim 32 in which the device is a pig.

34. A method according to claim 32 in which the method includes the step of collecting information on the pipeline and/or the step of altering the pipeline via cleaning or repair.
